(19) United States
(12) Patent Application Publication
(10) Pub. No.: US 2015/0017560 A1
(43) Pub. Date: Jan. 15, 2015

(54) Functional Module for a Coolant Circuit of a Fuel Cell System and Method for Producing a Functional Module and Container for a Coolant Circuit of a Fuel Cell System

(71) Applicant: Daimler AG, Stuttgart (DE)

(72) Inventors: Mario Mittmann, Owen (DE); Ralf Hoess, Stuttgart (DE); Herbert Schulze, Stuttgart (DE); Matthias Wuest, Stuttgart (DE); Christoph Koch, Kirchheim (DE); Clemens Schwab, Wendlingen (DE); Bianca Limbaecher, Koengen (DE); Joris De Jong, Esslingen a.N. (DE)

(21) Appl. No.: 14/374,139

(22) PCT Filed: Dec. 15, 2012
(86) PCT No.: PCT/EP2012/005178

§ 371 Date: Jul. 23, 2014

(30) Foreign Application Priority Data
Jan. 24, 2012 (DE) 10 2012 001 191.1

(51) Int. Cl. H01M 8/04

(52) U.S. Cl. CPC H01M 8/04067; H01M 8/04701; H01M 2250/20
USPC 429/436; 429/535

(57) ABSTRACT

A functional module for a coolant circuit of a vehicle fuel cell system includes a container having an ion-exchange material and a pump device for the coolant fluidically coupled to each other in such a manner that a coolant inlet and a coolant outlet of the pump device are connected to a coolant outlet and a coolant inlet of the container. The container surrounds at least one region of the pump device that has a conveying unit of the pump device at least in certain areas around the outer circumference.

### BACKGROUND AND SUMMARY OF THE INVENTION

Exemplary embodiments of the invention relate to a functional module for a coolant circuit of a fuel cell system for a vehicle. The functional module comprises a container having an ion-exchange material, and a pump device for the coolant. A coolant inlet and a coolant outlet of the pump device are fluidically coupled to a coolant outlet and a coolant inlet of the container. Furthermore, exemplary embodiments of the invention relate to a method for producing such a functional module for a coolant circuit of a fuel cell system and to a container for a coolant circuit.

With regard to conductivity, thus with regard to ions dissolved in the coolant, the coolant of a fuel cell system should be as pure as possible. This is in particular necessary because a fuel cell system for mobile applications, thus, for instance, for a vehicle, is designed for generating high voltage so that low conductivity of the coolant of a coolant circuit of the fuel cell system with regard to the insulation resistance of the coolant with respect to the vehicle body has to be ensured.

In order to ensure the purity of a coolant, a container having an ion-exchange material is integrated in the coolant circuit of the fuel cell system. Furthermore, it also possible to integrate in the coolant circuit a filter material that captures particles, thus dirt, strippings and residues, and therefore keeps them in particular away from the narrow coolant channels, which dissipate heat from the fuel cell stack, so as to prevent the coolant channels from clogging.

German patent document DE 10 2009 023 863 A1 describes an integrated coolant pump module, wherein a pump housing is formed integrally with a housing of a deionization filter. During operation of the coolant pump, a coolant inlet of the filter receives coolant from the high pressure side of the pump. The coolant then flows through a filter element, and a coolant outlet of the deionization filter is fluidically coupled to a low pressure side of the coolant pump.

Exemplary embodiments of the present invention are directed to a functional module of the aforementioned kind and a method for producing such a functional module having extended functionality.

In the case of the functional module according to the invention, the container comprising the ion-exchange material surrounds at least one pump device region that has a conveying unit of the pump device, at least in certain areas around the outer circumference. This is based on the knowledge that the conveying unit of the pump device releases heat during the pumping operation. If the container comprising the ion-exchange material now encloses the outer circumference of the conveying unit, it can be ensured that cooling of the pump device is provided particularly well in that heat is dissipated via the coolant flowing through the ion-exchange material. Likewise, in cold weather, the conveying unit of the pump device can contribute to the transmission of heat to the coolant for heating purposes. Thus, the functional module has extended functionality.

In addition, through the shape of the container, which is adapted to the shape of at least the conveying unit of the pump device, it can be ensured that only that container comprising the ion-exchange material is used that is designed for the coolant circuit and is adapted thereto. In this manner, proper cleaning of the coolant and high functional reliability is ensured.

The container and the conveying unit of the pump device—or the pump device as a whole—can each have identical geometrical shapes, e.g., the shape of a ring, a cylinder, a plate or the like, and the cross-sectional area of the container and at least the conveying unit can have the shape of a rectangle, a square, a circle or the like. Such an adapted, complementary shape ensures that only the matching container can be fitted around the conveying unit or the pump device.

Since there is a particularly great pressure difference between the coolant inlet of the pump device and the coolant outlet of the pump device, a particularly consistent throughput or a particularly good flow through the entire ion-exchange material can be ensured by connecting the container comprising the ion-exchange material in parallel to the coolant inlet and the coolant outlet of the pump device. Fluidically coupling the coolant inlet and coolant outlet of the pump device and the container to each other thus provides that a particularly high level of pressure for the flow through the ion-exchange material is available.

In particular, a positive locking and/or nonpositive locking connection of the container to the pump device can be provided. Thereby, the container can be installed in a particular simple and fast manner and without additional holders, and the container is securely retained on the pump device, even in the case of vibrations (shaking) which are typical for vehicle operation. To this end, a spring, a thread, a lever, a clamp or the like can be used, and the container can be fixed guided in grooves, rails or the like on the pump device.

In particular, the container can be fastened to the pump device in a guided manner, by plugging and/or screwing and/or snapping it in. Reaching a desired mounting position can be communicated to the operator in a tactile or audible manner and/or via an end stop. Also, a defined revolution, for example, a quarter or half of a full revolution of the container can be required for reaching the intended mounting position.

In an advantageous configuration of the invention, the container and at least the conveying unit of the pump device are arranged axially parallel, wherein the conveying unit is arranged, at least over a portion of its direction of longitudinal extent, in a receiving chamber formed by the container. This ensures particularly good heat transfer from the conveying unit to the coolant flowing through the container during operation of the coolant circuit. This applies in particular if the container and the conveying unit or the container and the pump device are arranged coaxially.

It is also of advantage if the container comprises a coil containing the ion-exchange material and which is formed to circumferentially extend at least around the conveying unit of the pump device. This ensures a particularly long path of the coolant flow around the conveying unit of the pump device, which is beneficial for a particularly extensive heat transfer from the conveying unit to the coolant.

Furthermore, it was found to be advantageous if the container rests at least in certain areas against a component of the fuel cell system, which component is different from the pump device and releases heat during operation. In this way, heat can be dissipated not only from the pump device, but also from this further component via the coolant flowing through the container. This component can be, for example, a compressor, a turbocharger, an anode module, a cathode module and/or power electronics of the fuel cell system.

In another advantageous configuration of the invention, the container is substantially trough-shaped, wherein the region comprising the conveying unit of the pump device is enclosed by the container around the outer circumference and towards a front side. This ensures a particularly extensive contact between the conveying unit and the container, which results in particularly good cooling during the operation of the coolant circuit. In addition, a particularly compact design of the functional module is implemented in this manner.

The functional module can comprise a cover element by means of which the container can be shielded from the surroundings, wherein a spring element is arranged between the cover element and the container, by means of which spring element the coolant inlet and/or the coolant outlet of the container can be brought into abutment with the coolant inlet and/or the coolant outlet of the pump device. Thus, on the one hand, a tightly fitting fluidic coupling of the container with the pump device is provided and, on the other, the container is protected particularly well against environmental influences.

It is also of advantage if the coolant inlet and/or the coolant outlet of the container has a separating layer which, by fluidically coupling with the coolant outlet and/or the coolant inlet of the pump device, can be destroyed by means of an actuating element. Thus, contamination of the ion-exchange material prior to coupling the container to the pump device is prevented by the separating layer, and a path for the coolant towards the ion-exchange material is provided only upon fluidically coupling the container and the pump device. In particular, avoiding penetration of humidity into the ion-exchange material prevents the latter from aging and thus enables a particularly long storage period prior to the use of the container in the coolant circuit. The same applies to the escape of moisture from the ion-exchange material, which can result in severe dehydration thereof and thus in aging.

The separating layer or membrane can also enclose the complete container as a kind of protective casing and thus can shield the ion-exchange material, in particular an ion-exchange resin, against external influences such as humidity and contamination. However, a vacuum can also be provided in the container to prevent the ion exchange material from undesired aging. Plugs and/or removable or tearable foils or the like can also be provided instead of a separating layer. Also, as an alternative, destroying the separating layer can be carried out by an operator, for example by peeling off or tearing open, if no actuating element is provided which effects the destruction of the separating layer when installing the container in the functional module.

In order for the separating layer to release at least one passage for coolant in a particularly simple and defined manner, in particular, a perforation and/or weakening of the separating layer can be provided. Such a perforation can be star-shaped, for example, or a section of the separating layer can be flipped open like a flap if the marginal regions of the flap are formed as weakenings of the separating layer.

In order to destroy the separating layer, the actuating element that is formed, for example, as a cone or a spike or the like, can in particular be arranged on the side of the pump device so that upon fluidically coupling the container to the pump device, the destruction of the separating layer takes place automatically.

Furthermore, it is preferred that a pressurization element is provided that exerts pressure onto the ion-exchange material located in the container. Thus, optimal functionality of the ion-exchange material can be permanently ensured. The pressurization element can be formed like a spring that prevents that a dead volume is formed in the volume taken up by the ion-exchange material. Thereby, a homogenous flow through the ion-exchange material can be achieved and the formation of preferred flow channels through the ion-exchange material can be prevented. This improves the effectiveness of the ion-exchange material in the coolant circuit.

The spring, for example, can press onto a movable piston arranged within the container. However, it is also possible that a filter material, which can be provided in the form of a glass fiber fleece, a membrane, a plastic mesh, a metal mesh or a frit, e.g. from borosilicate glass, effects the compression of the ion-exchange material, for example by the swelling of the filter material. Thus, the ion-exchange material is retained in the container under the pressure of the filter material. Contamination of components of the coolant circuit is also prevented by the filter material.

It is also of advantage if the container has at least one actuating element by means of which a closure element can be actuated that is adapted for closing the coolant inlet and/or the coolant outlet of the pump device. If, to be specific, the coolant inlet and/or the coolant outlet comprises the closure element, the coolant inlet and/or the coolant outlet thus are closed if the container is not connected to the pump device. Such an automatic closing mechanism ensures that when replacing the container, the closure element closes the associated inlet or outlet immediately after decoupling the container from the pump device. In this manner, no contaminants can get into the coolant. Closing is effected simply by disassembling the container, and when coupling the container to the pump device, the actuating element ensures that the closure element is moved into an open position. The closure element also ensures that no loose ion-exchange material or ion-exchange material as bulk goods or packaged in bags or the like can be introduced into the coolant circuit. Opening the closure element takes place only upon installing the container in that the actuating element moves the closure element.

A latch or a slider, a check valve, a movable cover flap, a rotary disc or the like can be used as a closure element. Furthermore, for moving the closure element, a spike or pin, a cone, an eccentric, a wedge, a ball or a half-ball or a cam can be provided as an actuating element. Thus, a particularly reliable actuation of the closure element can be achieved.

Additionally or as an alternative to mechanical actuation of the closure element by means of an actuating element, a switch can be actuated when assembling the container, wherein actuating the switch, by means of an actuator, then provides for the closing by means of the closure element. For example, an electromechanical switch such as a micro-contact switch or magnetic switch can open or close an electrical contact. Opening or closing the contact can result here in unblocking or blocking the coolant inlet and/or coolant outlet. Such an electrical contact can be configured as a finger contact, for example.

Opening and closing the electrical contact can additionally or alternatively ensure that the electrical energy flow to a functional unit of the coolant circuit is influenced or interrupted. This can take place directly or via a control device. A functional unit of the coolant circuit, which functional unit is activated for this purpose, for example, an electric pump or an electric control valve can influence the coolant flow. Through this it can be ensured that no further supply of coolant takes place as soon as the container is decoupled from the pump device.

Additionally or alternatively, a switch that is activatable in a contact-free manner can be provided, for example a magnetic passive switch, and/or the contact-free switch can comprise a chip as it is used in a RFID system (radio frequency identification system). Such contact-free switches or RFID chips can ensure that the coolant inlet and/or the coolant outlet is opened or closed, depending on whether the container is coupled to the pump device or disassembled.

However, it can also be provided that it is ensured by such contactlessly activatable switches that only the associated container can be coupled to the pump device, or otherwise operating the coolant circuit is prevented. This is in particular possible by using an RFID chip. Furthermore, it is also possible to generate a signal which, for example, activates a warning message in the instrument cluster of the vehicle and/or prevents the fuel cell system from starting if manipulation or the installation of an unidentified container in the functional module is detected. Furthermore, the signal can also generate error codes for diagnostic purposes, for instance during troubleshooting or short tests.

Also, via the signal that can be generated by a mechanical switch or a contactlessly activatable switch, the time of coupling the container to the pump device and/or the operating period of the container can be determined, and a corresponding data value can be stored in a control device. Thus, a conclusion can be drawn on the state of the ion-exchange material, in particular on the effectiveness thereof.

According to another aspect of the invention, correct installation of the container in the functional module can be detected based on the presence of coolant in the container. To be more specific, as long as the container is not in contact with the coolant and thus is dry, the ion-exchange material and optionally a filter material are also unused. By using or employing the ion-exchange material and optionally the filter material, thus, when they come into contact with the coolant, a change in the state of these materials takes place. The presence of coolant in the container can be detected here by means of a measuring device, for example by an inductive measuring process in which a coil arranged on or in the region of the pump device generates in each case a different magnetic field, depending on whether or not coolant is present in the container.

Another possibility of evaluating the state of the ion-exchange material and thus the period of use thereof is to make a wall of the container partially or completely transparent so that the coolant and the ion-exchange material are visible from the outside. Thus, a functional check and diagnosis can be performed visually.

Also, the ion-exchange material in the container can be colorless or colored in the used-up unsaturated state, and in the saturated state, thus in the state in use, it can have a different coloration which is detectable in particular with the human eye. Such a saturation indicator of the ion-exchange material is advantageous, especially if flexible maintenance intervals are provided and/or if a service department inspects the container as part of repair works on the coolant circuit of the fuel cell system.

The ion-exchange material can fill up the container completely or in part. It can be secured on the inner side of a wall of the container, for example in pockets, or it can be non-detachably embedded, for example chemically bonded, in the wall material. Furthermore, it can be adhered to the wall of the container, for example. If the ion-exchange material is not fixedly connected to the container, simple exchanging of the ion-exchange material is enabled.

In order to implement simple and fast exchange of the ion-exchange material, it can be accommodated, for example, in a separate container, for example a casing or cartridge. This container, in turn, can be accommodated in the container that is provided for the ion-exchange material and optionally for a filter material. It is then possible to disassemble the container that contains both the ion-exchange material and optionally the filter material and to replace the separate casing or cartridge or the like including the used-up saturated ion-exchange material at a clean workplace, in particular under clean-room conditions. However, the direct exchange of the separate casing or cartridge when the container is still installed in the functional module is also possible.

Preferably, self-sealing interfaces, for example in the form of membranes and/or check valves, are provided on the container and/or the pump device so as to prevent the coolant from escaping during installation or disassembly of the container. Thus, a simple, fast and clean mounting of the new container can be ensured as this is of advantage for service work, for example as part of maintenance and/or repair work. For this purpose it is beneficial if the container is protected from dirt when packaged, transported and delivered, and if the coolant circuit is opened only for a short time in order to install the container.

By using self-sealing interfaces at the coolant inlet and the coolant outlet of the container and/or the pump device, the length of connecting hoses can be reduced. This has a positive effect on packaging and the weight of the component. Such a reduced weight and compact packaging is in particular advantageous if the coolant circuit is intended for use in a fuel cell system for a vehicle.

In the installation position, the container can be aligned perpendicular or inclined with respect to a horizontal, or an alignment substantially parallel to the horizontal can be provided. It is also advantageous if the flow passes through the ion-exchange material from bottom to top, thus against gravity. Thus, a particularly homogenous flow can be ensured.

Materials that can be used for the components of the functional module that are in contact with the coolant are, for example, plastics, rubber, stainless steel, fiber-reinforced plastics, in particular glass-fiber-reinforced plastics or the like, which are compatible with the usually deionized coolant. This applies also to closure elements and actuating elements for moving closure elements and also for a potential separating layer, for example a foil (e.g. sealing foil or closure foil) or a membrane that closes the coolant inlet and/or the coolant outlet of the container.

In the method according to the invention for producing a functional module for a coolant circuit of a fuel cell system, a coolant inlet and a coolant outlet of a container comprising an ion-exchange material are fluidically coupled to a coolant outlet and a coolant inlet of a pump device for the coolant. Here, at least one region of the pump device, which region comprises at least one conveying unit of the pump device, is enclosed by the container at least in certain areas around the outer circumference. A functional module produced in this manner has an extended functionality since during the operation of the coolant circuit, heat can be dissipated particularly well from the conveying unit of the pump device via the container containing the ion-exchange material.

In the case of the container according to the invention for a coolant circuit of a fuel cell system provided for a vehicle, the container comprises an ion-exchange material, a coolant inlet and a coolant outlet. The container can be fluidically coupled to a pump device of the coolant circuit. Here, the container is formed in such a manner that it surrounds at least one region of the pump device, which region comprises a conveying unit of the pump device, at least in certain areas around the outer circumference. A container formed in this manner can be mounted on the pump device while providing good heat conductivity so that optional additional cooling of the pump device can be ensured particularly well in that heat is dissipated via the coolant that flows through the ion-exchange material. Likewise, in cold weather, the conveying unit of the pump device can contribute to the transmission of heat to the coolant for heating purposes.

The preferred embodiments and advantages described for a respective aspect of the invention also apply to further aspects of the invention and vice versa. Furthermore, the advantages and preferred embodiments described for the functional module according to the invention apply also to the method according to the invention for producing the functional module.

The features and feature combinations mentioned above in the description as well as the features and feature combinations mentioned below in the description of the figures and/or shown in the figures alone can be used not only in the respective stated combination, but also in other combinations or alone without departing from the scope of the invention.

### BRIEF DESCRIPTION OF THE DRAWING FIGURES

Further advantages, features and details of the invention arise from the following description of preferred exemplary embodiments and from the drawings in which identical or functionally identical elements are indicated with identical reference numbers. In the figures:

FIG. 1 shows in a schematic perspective view a functional module for a coolant circuit of a fuel cell system which comprises a coolant pump and a container containing an ion-exchange material, wherein the container surrounds the coolant pump around the outer circumference over the entire length of the coolant pump;

FIG. 2 shows in a schematic perspective view another functional module of this kind, wherein the container encloses the coolant pump around the outer circumference only over a portion of the length of the coolant pump;

FIG. 3 shows a view on a front side of the functional module according to FIG. 1 or FIG. 2;

FIG. 4 shows the functional module with the container surrounding the coolant coaxially around the outer circumference, wherein the container is hexagonal;

FIG. 5 shows the functional module with the container surrounding the coolant coaxially around the outer circumference, wherein the container is substantially rectangular;

FIG. 6 shows the functional module with the container surrounding the coolant coaxially around the outer circumference, wherein the container is octagonal;

FIG. 7 shows a sectional view through the functional module, in which the flow of coolant through the coolant pump and the container is illustrated;

FIG. 8 shows a functional module having a trough-shaped container which encloses a conveying unit of the coolant pump around the outer circumference, prior to mounting the container to the coolant pump;

FIG. 9 shows the functional module according to FIG. 8 in the mounted state;

FIG. 10 shows a functional module prior to mounting the trough-shaped container to the coolant pump, wherein a coolant inlet and a coolant outlet of the container are closed by membranes which are pierced during assembly by spikes arranged on the coolant pump side;

FIG. 11 shows further possible shapes of actuating elements by means of which the membranes according to FIG. 10 can be pierced;

FIG. 12 shows a first possibility of fixing the container on the coolant pump;

FIG. 13 shows a second possibility of fastening the container to the coolant pump;

FIG. 14 shows a functional module with a container, the shape of which is adapted to the shape of a receptacle formed by the coolant pump;

FIG. 15 shows a functional module according to FIG. 14, wherein in addition at least one switch is actuated when mounting the container to the coolant pump;

FIG. 16 shows the unblocking of a coolant line running into the coolant pump by means of a latch which is moved by a pin arranged on the container; and

FIG. 17 shows a further possibility of opening a slider which closes the coolant line running into the coolant pump, by mounting the container to the coolant pump.

### DETAILED DESCRIPTION

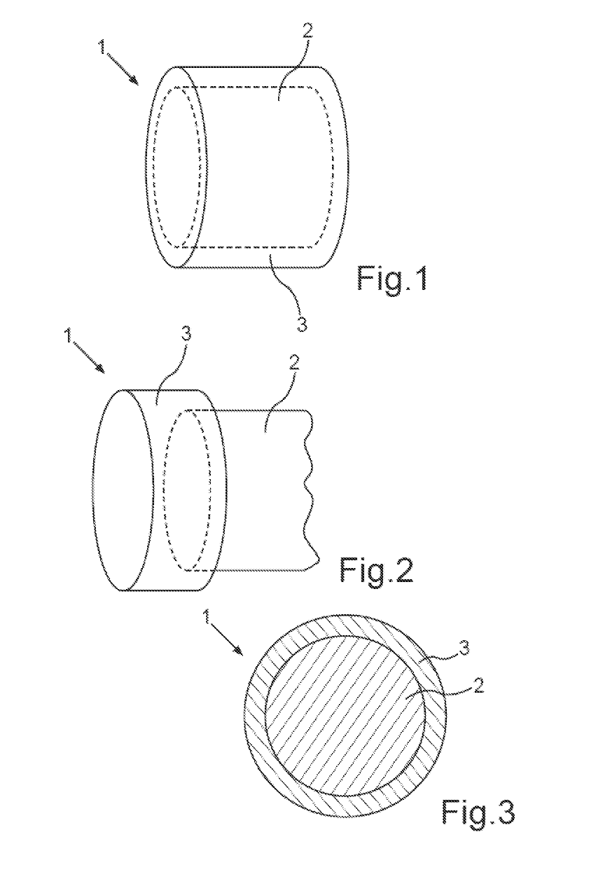

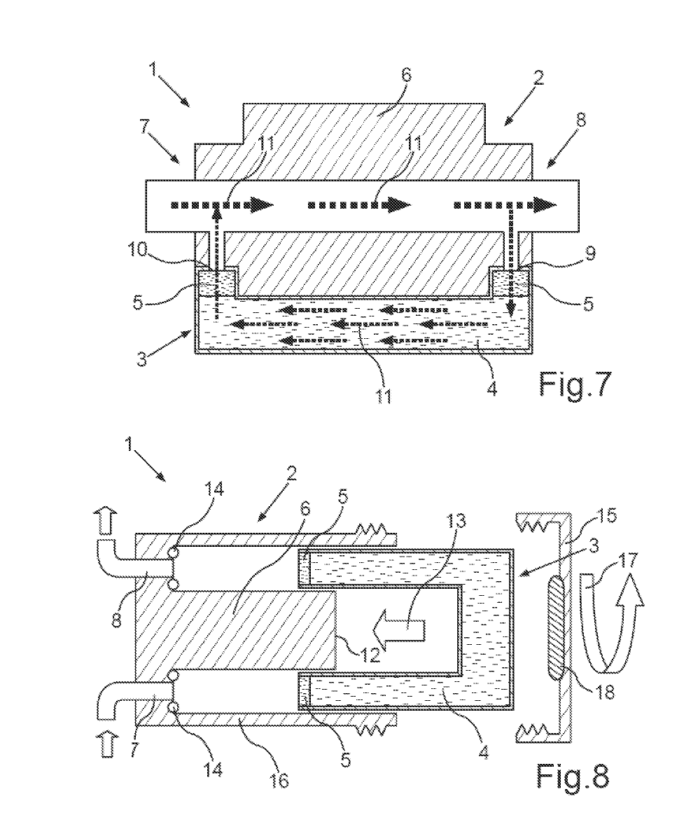

A functional module 1 for a coolant circuit of a fuel cell system of a vehicle, schematically shown in FIG. 1, comprises a coolant pump 2 and a container 3 in which an ion-exchange material 4 is arranged (cf. FIG. 7). A filter material 5 that retains particles, e.g. particles of the ion-exchange material 4 transported in the coolant, can also be arranged in the container 3 (cf. FIG. 7).

In the variant of the functional module 1 shown in FIG. 1, the container 3 surrounds the coolant pump 2 completely over the entire axial length of the coolant pump 2. The coolant pump 2 and the container 3 are arranged coaxially here.

In the variant of the functional module 1 shown in FIG. 2, the container 3 likewise surrounds the coolant pump 2 around the outer circumference, however not over the entire length of the coolant pump 2 but only over a portion thereof. However, in this configuration, a front side end of the coolant pump 2 is also covered by the container 3.

FIG. 3 shows the coaxial arrangement of the coolant pump 2 and of the container 3 enclosing the coolant pump 2 particularly well.

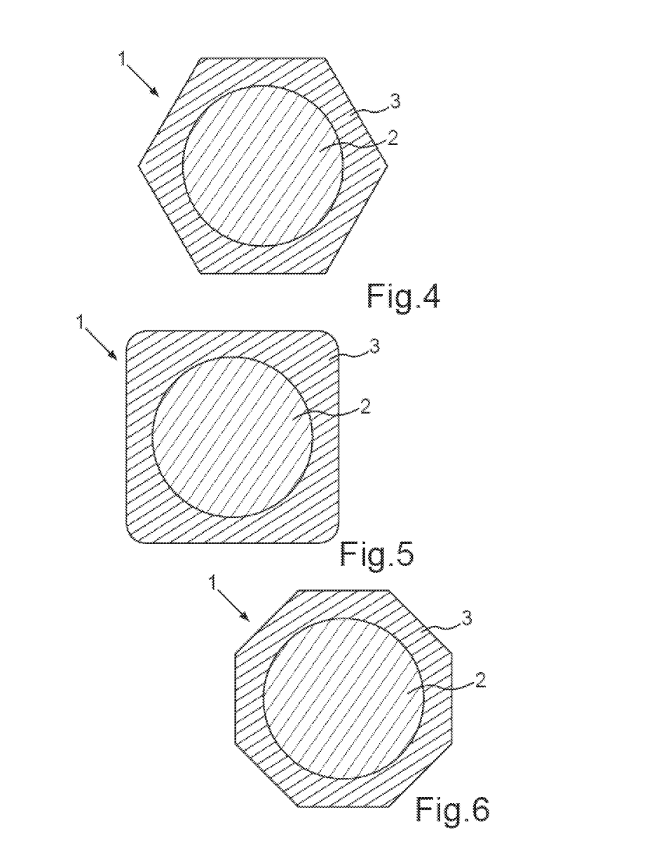

While the inner contour of the container 3 is adapted to the outer contour of the coolant pump 2, the outer contour of the container can have different shapes and, for example, can be hexagonal (cf. FIG. 4), substantially rectangular or square (cf. FIG. 5), or an octagonal shape of the outer contour of the container 3 can be provided (cf. FIG. 6).

FIG. 7 illustrates the flow of the coolant through the coolant pump 2 on which the container 3 including the ion-exchange material 4 and the optional filter material 5 is arranged on the outer circumference. A conveying unit 6 of the coolant pump 2 feeds the coolant from a coolant inlet 7 on the low-pressure side towards a coolant outlet 8 on the high-pressure side of the coolant pump 2. The conveying unit 6 can comprise vanes or the like by means of which the coolant can be moved in the direction of the flow arrows 11 (not shown).

A coolant inlet 9 of the container 3 is connected to the coolant outlet 8 of the coolant pump 2, and a coolant outlet 10 of the container 3 is connected to the coolant inlet 7 of the coolant pump 2. Flow arrows 11 indicate the direction of the coolant flowing through the coolant pump 2 on the one side and through the container 3 on the other side. Thus, the container 3 is connected to the coolant pump 2 in parallel to the coolant inlet 7 and the coolant outlet 8 of the coolant pump.

Through this, the particularly high pressure difference between the coolant outlet 8 and the coolant inlet 7 of the coolant pump 2 is utilized for moving a partial flow of the coolant through the filter material 5 and the ion-exchange material 4. This provides for a particularly uniform flow through the filter material 5 and in particular through the ion-exchange material 4. However, it is not the entire coolant flow but only a partial flow of the coolant that is pumped through the ion-exchange material 4, wherein the ion-exchange material causes a high pressure loss.

Through the arrangement of the container 3 on the pump device 2, wherein the container encloses at least the conveying unit 6 around the outer circumference at least in certain areas, heat released from the conveying unit 6 can be dissipated via the container 3. The container 3 and in particular the coolant flowing through the ion-exchange material 4 and the (optional) filter material 5 provide for a particularly good cooling of the conveying unit 6 of the coolant pump 2 during the operation of the coolant circuit.

In the functional module 1 shown in FIG. 1, the container 3 is substantially trough-shaped and in the state mounted to the coolant pump 2, it encloses the conveying unit 6 of the coolant pump 2 around the outer circumference and towards a front side 12 of the conveying unit 6.

During assembly, the container 3 is first attached onto the conveying unit 6 according to a direction indicated by a movement arrow 13 in FIG. 8 so that the coolant inlet and the coolant outlet of the container 3 are coupled to the coolant inlet 7 and the coolant outlet 8 of the coolant pump 2. Here, sealing rings 14 provide for a tightly fitted fluidic coupling of the container 3 to the coolant pump 2.

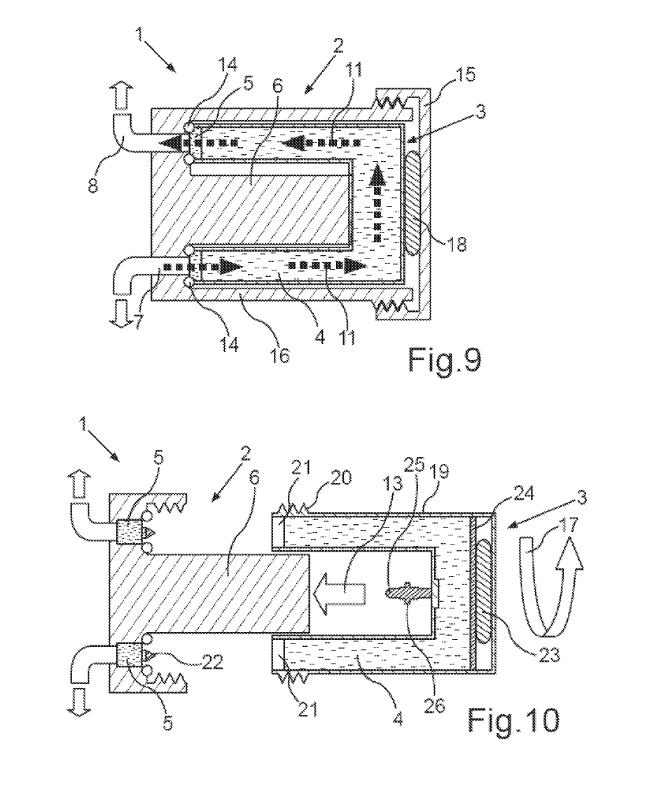

Subsequently, a cover 15 is screwed onto a wall 16 of a housing of the coolant pump 2, as is illustrated in FIG. 8 by another movement arrow 17. The wall 16 surrounds here again the container 3 around the outer circumference. A pressurization element, for example in the form of a spring 18 or a cushion comprising a compressed gas, is arranged between the cover 15 and the container 3. In the state of the container 3 mounted to the coolant pump 2 (cf. FIG. 9), this spring 18 ensures that the coolant inlets and coolant outlets of the coolant pump 2 and the container 3, which correspond with each other, are pressed against each other.

In FIG. 9, the flow arrows 11 illustrate the coolant flow through the ion-exchange material 4 when the cover 15 is screwed onto the wall 16 of the housing of the coolant pump 2 and the coolant pump 2 is fluidically coupled to the container 2.

In the variant of the functional module 1 shown in FIG. 1, in contrast to the embodiment in FIG. 9, no separate cover is provided, but an outer wall 19 of a housing of the container 3 has a screw thread 20. During mounting, the substantially trough-shaped container 3 is first slid according to the movement arrow 13 in FIG. 10 onto the conveying unit 6 of the coolant pump 2. Subsequently, the container 3 is screwed to the housing of the coolant pump 2 by means of the screw thread 20. This screwing movement is illustrated in FIG. 10 by another movement arrow 17.

In this configuration of the functional module 1, the ion-exchange material 4 is arranged on the side of the container 3, and the filter material 5 is arranged on the side of the coolant pump 2. Moreover, the coolant inlet and the coolant outlet of the container 3 are closed by membranes 21 as long as the container 3 is not fluidically coupled to the coolant pump 2. Only upon attaching the container 3 to the coolant pump 2, the spikes 22 or similar actuating elements pierce the membrane 21 and the hydraulic coupling between the coolant pump 2 and the container 3 is established.

In the container 3 of this configuration, furthermore, a pressurization element, for example, in the form of a spring 23 or a gas-filled cushion is arranged which exerts pressure onto wall 24 which is movable in the manner of a piston within the container 3. This ensures that no dead volume occurs in the ion-exchange material 4, which otherwise would promote the formation of preferred flow channels through the ion-exchange material 4.

Furthermore, an actuating element in the form of a pin 25 is arranged at the container 3, which pin can additionally be provided with a mechanical coding 26 in the manner of a key bit. In such a case, the mechanical coding 26 ensures that in fact only that container 3 can be mounted that is intended for mounting to the coolant pump 2. When mounting the container 3 to the coolant pump 2, the pin 25 can actuate a closure element, for example in the form of a latch, a slider, a flap or a check valve, thereby enabling that coolant from the coolant pump 2 can flow into the container 3.

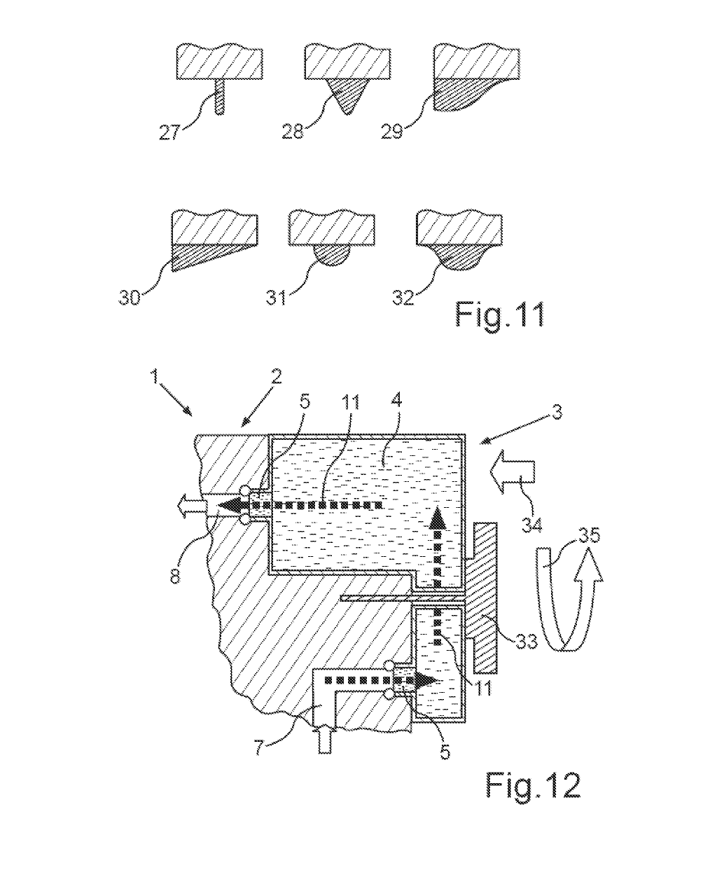

FIG. 11 shows further actuating elements, for example, in the form of a needle 27, a cone 28, an eccentric 29, a wedge 30, a ball or a half-ball 31 or a cam 32, which can carry out the piercing of the membranes 21 analogous to the spikes 22 shown in FIG. 10.

However, analogous to the pin 25 shown in FIG. 10, the actuating elements according to FIG. 11 can also effect the actuation of a closure element, for example of the slider, the latch, the flap or the check valve so as to unblock the coolant lines arranged on the side of the coolant pump 2.

FIG. 12 illustrates a possibility of fastening the container 3 to the coolant pump 2 by means of a knurled screw 33, wherein attaching the container 3 to the coolant pump 2 and tightening a screw head of the knurled screw 33 is illustrated by respective movement arrows 34, 35. The flow arrows 11 illustrate the flow through the ion-exchange material 4 in the container 3 when the container 3 is fastened to the coolant pump 2 during the operation of the coolant circuit.

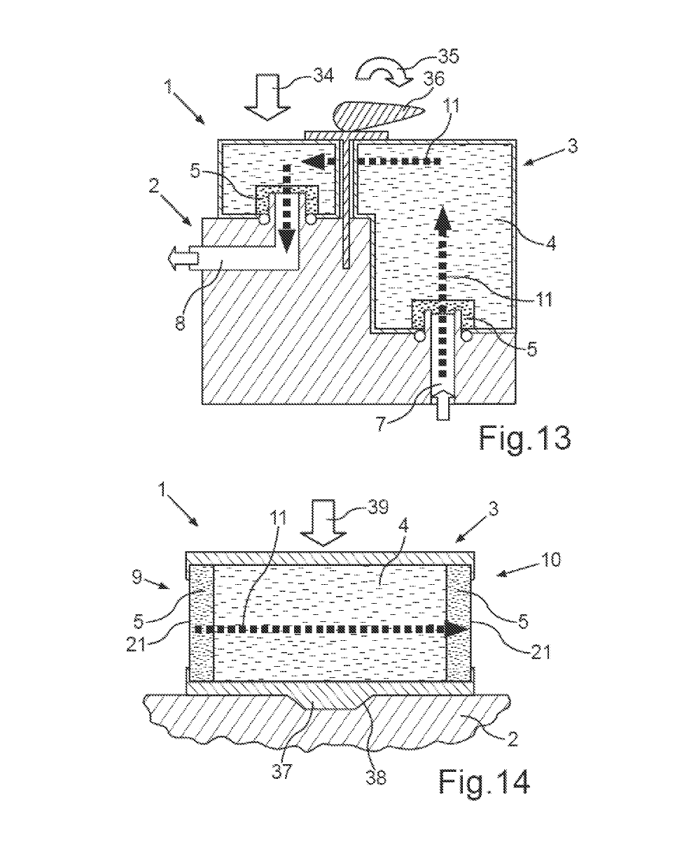

In the variant of the functional module 1 according to FIG. 13, the container 3 is fastened to the coolant pump 2 by means of an eccentric 36. Here too, attaching the container 3 to the coolant pump 2 and tightening the eccentric 36 is illustrated by respective movement arrows 34, 35.

In the variant of the functional module 1, which is schematically shown in FIG. 14, the outer wall of the container 3 has, for example, a conical projection 37 which is inserted into a corresponding recess 38 which is formed in the outer wall of the housing of the coolant pump 2.

Here too, the coolant inlet 9 into the container 3 and the coolant outlet 10 of the container 3 which are coupled to the coolant inlet and the coolant outlet of the coolant pump 2 are closed by the membranes 21 or similar separating layers which hermetically seal the container 3 until the fluidic coupling to the coolant pump 2 is established. Here, the container contains both the ion-exchange material 4 and the filter material 5. A flow arrow 11 illustrates the path of the coolant through the filter material 5 and the ion-exchange material 4, and a movement arrow 39 illustrates the direction when mounting the container 3 to the coolant pump 2.

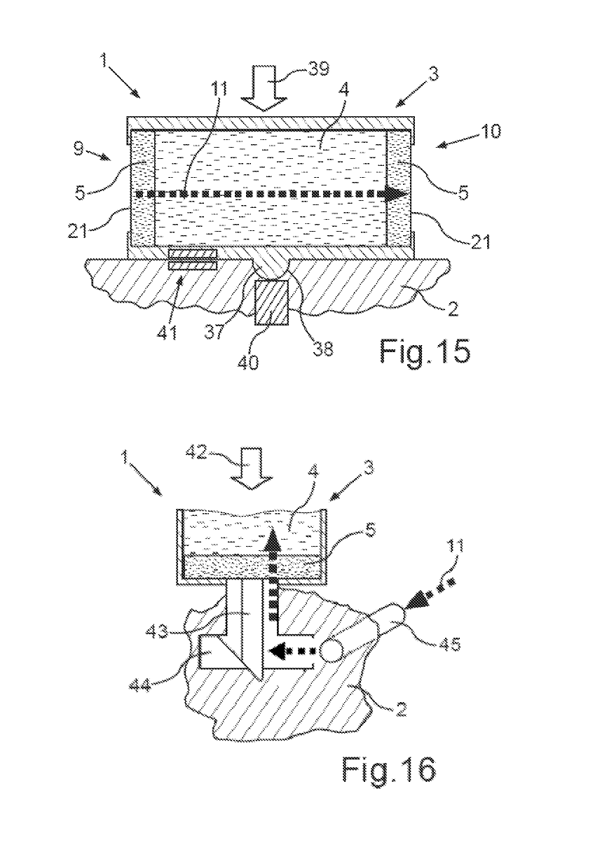

In the embodiment of the functional module 1 shown in FIG. 15, the projection 37 is hemispherical and, moreover, by inserting the projection 37 into the recess 38, an electrical contact switch 40 is closed. Closing the contact switch 40 can effect that closure elements such as a latch, slider, check valves, movable cover flaps, rotary discs or the like, which close coolant lines connected to the coolant pump 2, are opened.

However, actuating the contact switch 40 can also effect that the coolant pump 2 (which is electrically driven, for example) is supplied with electrical energy only after the contact switch 40 is closed, and the energy supply is interrupted when dismantling the container 3 from the coolant pump 2. Activating the coolant pump 2 can also be carried out directly, for example via a control device. The contact switch 40 can be configured as a micro-contact switch or magnetic switch, for example.

Additionally or alternatively, a contact-free switch 41 can be provided for effecting the execution of the above-mentioned functions. For example, a magnetic switch, for instance a magnetic passive switch (MAPPS), or a chip of an RFID system can be provided as a contact-free switch 41. Such a chip can also serve for identifying the container 3 and thus can additionally ensure that only that container 3 is installed in the coolant circuit that is suitable and provided for connecting to the coolant pump 2.

In the case of the functional module 1 according to FIG. 16, mounting the container 3 containing the ion-exchange material 4 and the filter material 5, in a mounting direction indicated by a movement arrow 42, causes a pin 43 arranged on the container 3 to push a latch 44 (only partially illustrated) to the left side. This moving of the latch 44 ensures that a coolant line 45 is opened which runs into the coolant pump 2. Thereupon, the coolant can flow into the coolant pump 2, as indicated in FIG. 16 by flow arrows 11, and from there into the container 3. In this configuration, the pin 43 is arranged in the region of the coolant inlet into the container 3.

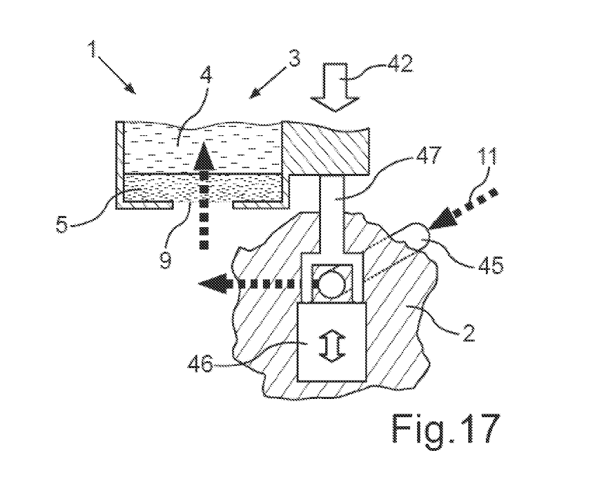

In contrast, in the variant of the functional module 1 shown in FIG. 17, an actuating element 47 provided for moving a slider 46 is arranged spaced apart from the coolant inlet 9 into the container 3. However, here too, actuating the slider 46 by the actuating element 47 effects that a coolant line 45 is unblocked, and the coolant—as indicated by the flow arrows 11—can flow into the coolant pump 2 and into the container 3. Here too, the mounting direction of the container 3 is illustrated by the movement arrow 42.

The latch 44 and the slider 46 can be moved in particular by a reset spring into a starting position that closes the coolant line 45 when decoupling the container 3 from the coolant pump 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE LIST

1 Functional module
2 Coolant pump
3 Container
4 Ion-exchange material
5 Filter material
6 Conveying unit
7 Coolant inlet
8 Coolant outlet
9 Coolant inlet
10 Coolant outlet
11 Flow arrow
12 Front side
13 Movement arrow
14 Sealing ring
15 Cover
16 Wall
17 Movement arrow
18 Spring
19 Wall
20 Screw thread
21 Membrane
22 Spike
23 Spring
24 Wall
25 Pin
26 Coding
27 Needle
28 Cone
29 Eccentric
30 Wedge
31 Half-ball
32 Cam
33 Knurled screw
34 Movement arrow
35 Movement arrow
36 Eccentric
37 Projection
38 Recess
39 Movement arrow
40 Contact switch
41 Switch
42 Movement arrow
43 Pin
44 Latch
45 Coolant line
46 Slider
47 Actuating element

1-11. (canceled)

12. A functional module for a coolant circuit of a vehicle fuel cell system, the functional module comprising:
a container with an ion-exchange material; and
a pump device configured to pump the coolant through the coolant circuit, the pump device including a coolant inlet and a coolant outlet fluidically coupled to a coolant outlet and a coolant inlet of the container,
wherein the container surrounds at least a region of the pump device having a conveying unit, at least in certain areas around an outer circumference of the conveying unit.

13. The functional module of claim 12, wherein the container and at least the conveying unit of the pump device are arranged axially parallel and coaxially, wherein the conveying unit is arranged, at least over a portion of its direction of longitudinal extent, in a receiving chamber formed by the container.

14. The functional module of claim 12, wherein the container comprises a coil containing the ion-exchange material and which is formed to extend at least around the outer circumference of the conveying unit of the pump device.

15. The functional module of claim 12, wherein the container is in abutment with at least one component of the fuel cell system, which component is different from the pump device and releases heat during operation.

16. The functional module of claim 12, wherein the container is substantially trough-shaped, wherein a region of the pump device that comprises the conveying unit is enclosed by the container around the outer circumference and towards a front side.

17. The functional module of claim 12, further comprising:
a cover element configured to shield the container towards a surrounding area, wherein a spring element is arranged between the cover element and the container, wherein the spring element is configured so that the coolant inlet and the coolant outlet of the container are respectively brought into abutment with the coolant outlet and the coolant inlet of the pump device.

18. The functional module of claim 12, wherein the coolant inlet and the coolant outlet of the container has a separating layer which, by fluidically coupling with the coolant outlet and the coolant inlet of the pump device, is destroyed by an actuating element arranged on a side of pump device.

19. The functional module of claim 12, further comprising:
a pressurization element configured to exert pressure on the ion-exchange material located in the container.

20. The functional module of claim 12, wherein the container has at least one actuating element formed as a spike, pin, cone, eccentric, wedge, ball, or cam, wherein the actuating element is configured to actuate a closure element configured to close the coolant inlet or the coolant outlet of the pump device.

21. A method for producing a functional module for a coolant circuit of a vehicle fuel cell system, the method comprising:
fluidically coupling a coolant inlet and a coolant outlet of a container having an ion-exchange material to a coolant outlet and a coolant inlet of a pump device for the coolant by enclosing at least one region of the pump device that has a conveying unit of the pump device by the container at least in certain areas around an outer circumference of the conveying unit.

22. A container for a coolant circuit of a vehicle fuel cell system, the container comprising:
an ion-exchange material;
a coolant inlet; and
a coolant outlet,
wherein the container is configured for fluidic coupling to a pump device of the coolant circuit,
wherein the container is configured such that it encloses at least one region of the pump device that has a conveying unit of the pump device, at least in certain areas around an outer circumference of the conveying unit.
